(19) United States
(12) Patent Application Publication
(10) Pub. No.: US 2004/0174787 A1
(43) Pub. Date: Sep. 9, 2004

(54) Recordable medium having a data recording area with an embedded non-recordable zone

(75) Inventor: Douglas M. Carson, Cushing, OK (US)

Correspondence Address: Fellers, Snider, Blankenship, Bailey & Tippens, Bank One Tower, 100 North Broadway, Suite 1700, Oklahoma City, OK, 73102-8820, US

(73) Assignee: Doug Carson & Associates, Inc., Cushing, OK (US)

(21) Appl. No.: 10/778,998

(22) Filed: Feb. 12, 2004

Related U.S. Application Data
(60) Provisional application No. 60/446,827, filed on Feb. 12, 2003.

(51) Int. Cl. G11B 7/00

(52) U.S. Cl. 369/53.21; 369/275.3; 369/59.25

(57) ABSTRACT

A recordable medium, an apparatus for forming the medium and a method for using the medium to support media authentication and copy protection efforts. A blank recordable comprises a plurality of concentric tracks arranged to form an addressable data recording area. Embedded within the data recording area is a non-recordable zone at one or more selected addresses. The non-recordable zone (recordable medium identification, or RMID zone) is configured to permit an attempted recording operation to record data to the zone, as well as to prevent successful readback of the data during a subsequent readback operation. An embossment is preferably supplied to the RMID zone such as a metalized layer of pits and lands, a layer of optically contrasting marks within the recordable medium, or a layer of dye. The embossment interferes with the ability to readback the data that was attempted to be written to the zone.

### RELATED APPLICATIONS

This application claims domestic priority under 35 U.S.C. § 119(e) to U.S. Provisional Application No. 60/446,827 filed Feb. 12, 2003.

### FIELD OF THE INVENTION

The present invention relates generally to the field of data storage systems and more particularly, but without limitation, to the prevention of unauthorized duplication of data written to an original medium, such as a pre-recorded optical disc, onto a blank medium, such as a recordable optical disc.

### BACKGROUND

Optical discs are a type of data recording media used to store a wide variety of digitally encoded data. Such discs are usually portable in nature and can be played in a variety of settings (personal computers, car audio players, home theater systems, handheld personal entertainment devices, home gaming systems, etc.).

A typical optical disc comprises a circular disc having one or more recording layers of light reflective material embedded in a refractive substrate. Each recording layer is disposed along a plane substantially normal to an axis about which the disc is rotated and stores data in the form of localized pits and lands along a continuously extending spiral track. A data transducing head uses a laser or similar light source to output a readback signal based on the different reflectivities of the pit and land areas. Decoding circuitry decodes the user data for output by the appropriate playback device.

During readback, an optical disc typically provides main channel (user) data, subcode (control) channel data, and error detection/correction (EDC) channel data. Main channel data comprise the desired user data stored on the disc (audio, video, computer software, etc.) in fixed-size user data blocks (sectors). Control channel data comprise sector header, timing and other types of control information to facilitate playback of the main channel data. EDC channel data indicate the extent to which EDC techniques (parity bits, Reed-Solomon error correction codes, etc.) have been employed to correct detected errors in the main channel and control channel data.

The user data portion of an optical disc can be readily retrieved using various reading devices and stored onto other storage devices such as computer hard discs, floppy discs and recordable optical discs (write-once or write-many). Optical disc recording devices will accept this user data portion and add the additional address codes, synchronization data, error detection and correction codes, modulation data etc. using built-in per-programmed encoder circuits to provide a duplicate disc that is a digital copy of the original. This process is sometimes referred to as digital extraction or ripping.

Another increasingly common methodology for copying an existing disc is to use what is sometimes referred to as analog duplication. In this case the original disc is continuously read from lead-in to lead-out to generate a readback signal that is then used to sequentially, directly record the same pit and land sequence on a second, duplicate disc. The duplicate disc thus nominally comprises a bit-for-bit copy of the original and includes all of the errors and copy protection bits as they appear on the original.

With the continued popularity of recordable optical media and the Internet, unauthorized copying of optical discs by ripping or analog duplication is becomingly increasingly easy to carry out by even the most casual of users. Accordingly, there remains a continued need for improvements in the art for media authentication and copy protection schemes that are easily implemented and difficult to detect and defeat.

### SUMMARY OF THE INVENTION

In accordance with preferred embodiments, the present invention is generally directed to a recordable medium, an apparatus for forming the medium and a method for using the medium to support media authentication and copy protection efforts.

In accordance with one aspect, a blank recordable medium comprises a plurality of concentric tracks arranged to form an addressable data recording area. Embedded within the data recording area is a non-recordable zone at one or more selected addresses.

The non-recordable zone (also referred to herein as a recordable medium identification, or RMID zone) is configured to permit a recording operation during which an attempt is made to write data to the zone. Regardless whether the attempt to write the data was successful, the non-recordable zone prevents the data from being successfully retrieved during a subsequent readback operation.

Preferably, the recordable medium is characterized as an optical disc of a write-once or write-many format. The non-recordable zone preferably comprises an embossment provided during manufacture of the recordable medium, such as a metalized layer of pits and lands, a layer of optically contrasting marks within the recordable medium, or a layer of dye. The embossment interferes with the ability to readback the data that was attempted to be written to the zone.

Preferably, a range of addressable sectors are defined by the plurality of tracks to provide the data recording area, and the non-recordable zone comprises at least one of said addressable sectors. The range of addressable sectors defined by the plurality of tracks are preferably defined by a frequency modulated pre-groove wobble of said tracks, and in some embodiments the pre-groove wobble is disrupted at the non-recordable zone to prevent successful recording and readback.

In accordance with another aspect, an apparatus is provided which forms a blank recordable medium having a non-recordable zone embedded within a data recording area as described above. The apparatus preferably comprises an embosser which supplies an embossment to the non-recordable zone.

In yet another aspect, a method is provided in accordance with the foregoing that includes a step of defining a disc authentication zone within an addressable data recording area of a first medium to correspond to a non-accessible zone embedded within an addressable data recording area of a second medium. As before, the non-accessible zone is configured to permit a recording operation to record data thereto and to prevent successful readback of said data therefrom.

The method further includes writing disc authentication information to the disc authentication zone which identifies the first medium as an authorized copy. In this way, a subsequent attempt to use the second medium to form a copy of the first medium results in an inability to retrieve the disc authentication information from the second medium. Preferably, the first medium is characterized as a pre-recorded optical disc and the second medium is characterized as a recordable optical disc, although the first medium can alternatively be characterized as a recordable optical disc as well

These and various other features and advantages which characterize the claimed invention will become apparent upon reading the following detailed description and upon reviewing the associated drawings.

### BRIEF DESCRIPTION OF THE DRAWINGS

FIG. 1 is a top plan representation of a pre-recorded optical disc (first disc) having a pre-recorded identification (PRID) zone (also referred to as a disc authentication zone) in accordance with preferred embodiments of the present invention.

FIG. 2 is a top plan representation of a corresponding recordable optical disc (second disc) having a recordable medium identification (RMID) zone (also referred to as a non-recordable zone) in accordance with preferred embodiments.

FIG. 3 illustrates the RMID zone of the recordable disc of FIG. 2 in accordance with a preferred embodiment.

FIG. 4 illustrates the RMID zone of the recordable disc of FIG. 2 in accordance with another preferred embodiment.

FIG. 5 illustrates the RMID zone of the recordable disc of FIG. 2 in accordance with yet another preferred embodiment.

FIG. 6 provides a functional block representation of a recording system configured to copy data from the pre-recorded disc of FIG. 1 to the recordable disc of FIG. 2.

FIG. 7 is a functional block representation of a readback system used to read data stored on the recordable disc of FIG. 2 by the system of FIG. 6.

FIG. 8 is a functional block representation of a system used to form the recordable disc of FIG. 2.

### DETAILED DESCRIPTION

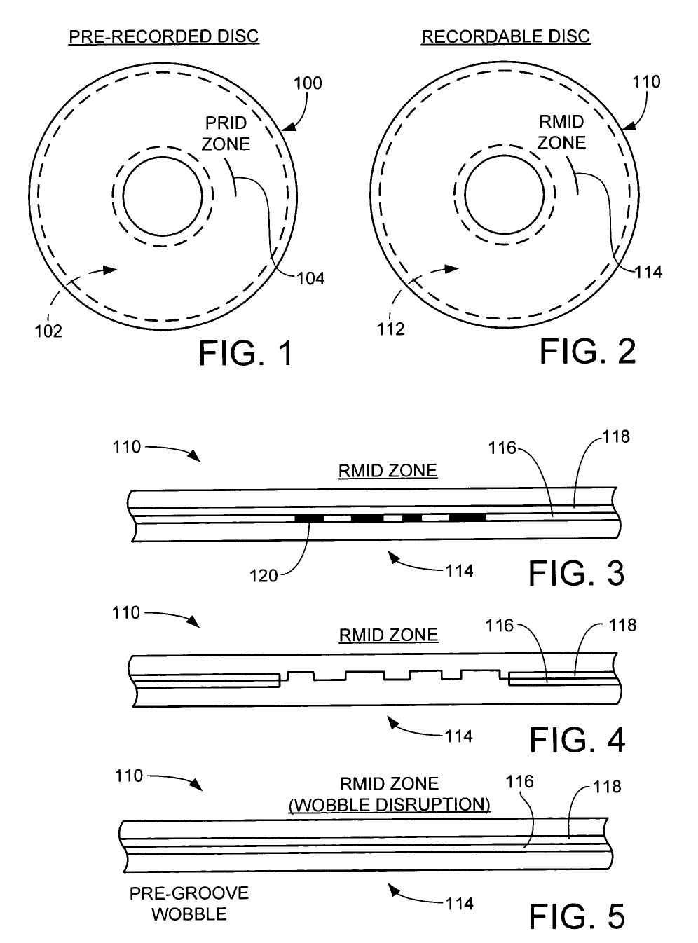

FIG. 1 shows a first optical disc 100. The first disc 100 is preferably a pre-recorded disc; that is, the disc stores recorded data in a data recording area 102 (bounded in broken line fashion). The data recording area 102 is embedded within an internal reflective layer of the disc 100 as a series of pits and lands. The pits and lands are arranged along a plurality of concentric tracks that circumferentially extend around the disc 100. The tracks can form a single continuous spiral or can be arranged as discrete, nested rings.

The recorded data in the data recording area 102 may be audio, video, computer ROM programming, or any combination thereof, on one or more embedded recording layers. The data are arranged in addressable sectors along the tracks in a conventional manner.

The first disc 100 is preferably generated using a mastering/stamper/replication process so that a population of nominally identical discs is provided. For purposes of discussion, it will be contemplated that the first disc 100 is a digital versatile disc (DVD) of selected format, such as a high density DVD (HD-DVD).

The first disc 100 is shown in FIG. 1 to include a pre-recorded identification (PRID) zone 104 embedded within the data recording area 102. The PRID zone, also referred to herein as a “disc authentication zone,” can be any predefined location on the disc 100 within the data recording area 102, and preferably comprises one or more contiguous or spaced apart sectors.

During the manufacturing process, selected disc identification information is written to the PRID zone 104 sufficient to identify the disc as an authentic, original disc. Such information can take any number of forms and can use any desired modulation format. As discussed below, during a readback operation the PRID zone 104 is accessed by a readback system and, upon verification of the contents of the PRID zone, the disc will be “unlocked” (i.e., the readback system will proceed to access the remaining portions of the data recording area 102).

FIG. 2 shows a blank recordable medium (second disc) 110. The second disc 110 has a format that generally conforms to the first disc 100, but without the pre-recorded information of the first disc 100. Thus, in the present example the second disc 110 is contemplated as comprising a blank recordable DVD compatible disc (such as a recordable HD-DVD disc) with a data recording area 112.

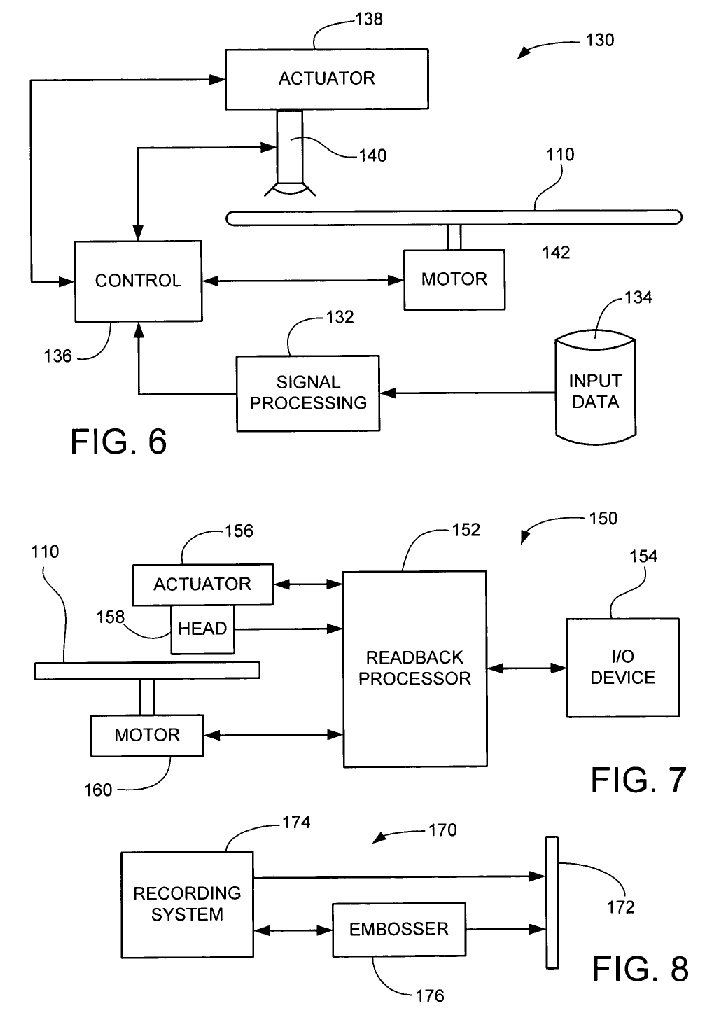

The data recording area 112 similarly comprises a series of concentric tracks (continuous spiral or discrete nested rings). The tracks are preferably provided with a frequency modulated pre-groove wobble which provides tracking and control information to a recording system (see FIG. 6 below) and which predefines the locations for various sectors of data to be written to the disc 110.

It is desirable to prevent a user from using the second disc 110 to create an unauthorized copy of the first disc 100. To defeat such unauthorized copying, the second disc 110 includes a recordable medium identification (RMID) zone 114 that is at the same location as the PRID zone 104 of the first disc 100.

Generally, the RMID zone 114, also referred to herein as a “non-recordable zone,” is configured to prevent the successful reading of data written thereto. Preferably, an embossment is employed at the RMID zone 114 that interferes with the readback of data that are otherwise successfully written to the zone, or otherwise prevents the writing of data to the zone in the first place. The embossment can be provided in a number of ways.

In some preferred embodiments, the second disc 110 is characterized as a write-once medium so that, once data are written to the data recording area 112, such data cannot be subsequently erased. As shown in FIG. 3, one configuration of such a medium employs a layer of dye 116 adjacent a reflective layer 118. For reference, readback access is accomplished in a direction up through the bottom of the disc 110.

As the layer of dye 116 is selectively exposed to the light of a write transducer, permanent stripes (darkened regions 120) are selectively formed. The stripes 120 and the reflective regions of the reflective layer 118 therebetween have different reflectivities that function as pits and lands during playback. Thus, one relatively straightforward way to provide the embossment is to pre-write the RMID zone 114 in a desired pattern (not corresponding to the PRID zone information) and leave the remaining portions of the data recording zone 112 undisturbed.

In other preferred embodiments, the embossment comprises a localized layer of pre-recorded pits and lands in the RMID zone 114, as depicted (in exaggerated fashion) in FIG. 4. The pre-recorded pits and lands can be on the same or a different internal surface as remaining portions of the data recording area 112. As will be recognized, the pits and lands are impervious to subsequent attempts to write data thereto or erase data therefrom. Thus, an advantage of the use of the embodiment of FIG. 4 is that the remaining portions of the data recording area 112 can have either a write-once configuration (as shown) or a write-many (erasable and rewriteable) configuration. A related embodiment employs a non-reactive dye or similar layer at the RMID zone 114 (such as in lieu of the dye 116 in FIG. 3) which provides the same general result.

Still other preferred embodiments do not specifically use a previously established embossment in the RMID zone 114, but otherwise configure the RMID zone 114 such that attempts to write data to and read data from the zone are disrupted. In one preferred approach, the aforementioned pre-groove wobble is disrupted or altered in the RMID zone 114, but remains undisturbed in remaining portions of the data recording area 112. In this way, the recording system cannot reliably track the addresses of the associated sectors to record data to the RMID zone 114. This approach is generally represented by FIG. 5.

The second disc 110 advantageously protects the contents of the first disc 100 in a manner that will now be described. FIG. 6 generally illustrates a recording system 130 configured to record data to the data recording area 112 of the second disc 102. In this case, the system 130 is contemplated as comprising a DVD-R type recorder.

The recording system 130 includes a signal processing block 132 that processes input data from a source 134. The signal processing block 132 provides encoded data to a control block 136 which, in turn, controls an actuator 138, light emitting transducer 140 and disc motor 142 to write the encoded data to the data recording area 112 of the second disc 110. Thus, the system 130 operates to form stripes (such as 120) in the layer 116 (see FIG. 3).

When a user attempts to copy the contents of the data recording area 102 of the first disc 100 to the second disc 110, at some point the recording system 130 will likely be instructed to attempt to write the contents of the PRID zone 102 to the RMID zone 112.

However, the configuration of the RMID zone 114 will be such that, when the recording system has completed writing the PRID zone data to the RMID zone 114, the contents of the recorded RMID zone 114 will not match the PRID zone 102. For example, the contents of the RMID zone 114 will remain unchanged (i.e., the writing attempt failed and the RMID zone remains as before), or the preexisting contents of the RMID zone 114 will serve to make the resulting contents of the RMID zone unintelligible.

When the user places the unauthorized copy (second disc 110) into a reader system 150 as shown in FIG. 7, the reader system 150 will not detect the correct authorization data from the RMID zone 114, and disc access will be denied. This is preferably carried out as follows.

The reader system 150 includes a readback processor 152 which communicates with an input/output (I/O) device 154, such as a personal computer. The readback processor 152 controls an actuator 156, optical pickup (transducing head) 158 and disc motor 160. During a readback operation the readback processor 152 processes a modulated signal from the head 158 to provide the originally stored data to the device 154.

During disc initialization, the device 154 commands a seek to move the head 158 to the RMID zone 114 to carry out a readback operation of that zone. The actual response of the reader system 150 to this command will depend upon the configuration of the RMID zone 114; that is, either the pre-recorded data (e.g., FIG. 4) or unintelligible data (e.g., overwritten data in FIG. 3) will be returned, or the system will attempt to read back the data but will be unable to successfully complete the command and, after a number of retries, report an error condition (e.g., FIG. 5).

The I/O device 154 will thus deny further access to the second disc 110 on the basis that the readback processor 152 failed to return the requisite disc authentication information from the PRID zone 102 of the first disc 100. A user message to that effect may also be displayed by the device 154 at this time.

Preferred methodologies for forming the second disc 110 in accordance with the foregoing discussion will now be briefly discussed. As those skilled in the art will recognize, recordable media, whether of a write-once or a write-many format, are often formed using a mastering/stamping/replication process wherein a master disc is initially formed with a desired pattern, stampers are grown from the master disc, and the stampers are used in an injection molded process to form the final replicated discs. When multi-layer discs are generated (such as hybrid discs), individual injection molded articles are formed with individual layers which are then subsequently assembled into the final discs.

Accordingly, FIG. 8 provides a simplified functional diagram for a disc forming system 170 used to form an injection molded article 172 that constitutes at least a portion of the second disc 110. The system 170 employs a substantially conventional recording system 174 that is generally similar to the system 130 shown in FIG. 6, except that the recording system 174 is utilized to form the aforementioned frequency modulated pre-groove wobble in a layer of photoresist or similar material that will ultimately result in the pre-groove wobble in the data recording area 112.

The system 170 is further shown to include an embosser 176 used to provide the embossment for the RMID zone 114 as discussed above. The configuration of the embosser 176 will depend upon the desired format for the RMID zone 114. For example, when a pre-recorded portion of pits and lands are required (such as in FIG. 4), the embosser 176 includes an appropriately configured stamper to impart this desired pit and land pattern to the article 172. Similarly, when a localized impervious dye is required, the embosser 176 applies such to the article 172.

Alternatively, when the embossment comprises a prewritten series of stripes (as in FIG. 3), the embosser 176 generally takes a format substantially similar to the recording system 130 of FIG. 6 and is used to selectively expose the dye layer 116 (FIG. 3) in the region of the RMID zone 114 to provide the desired prewritten pattern.

Finally, when the RMID zone 114 is configured to have a disrupted pre-groove wobble, the embosser 176 is characterized as a control circuit which communicates with the recording system 174 during the pre-groove wobble mastering process to disrupt the pre-groove in the area associated with the RMID zone 114. As each of these considerations are well within the level of skill of an ordinary artisan, further details concerning the system 170 are unnecessary in view of the foregoing discussion.

It will now be appreciated that the various preferred embodiments presented above provide several advantages over the prior art. The RMID zone 114 can be easily and inexpensively incorporated into existing recordable media manufacturing processes.

Unlike prior art authentication and copy protection schemes which are typically resident on the disc from which the data are being copied from (i.e., the first disc), the embodiments presented herein use the configuration of the disc to which the data are to be copied (i.e., the second disc) to enact said protection.

Thus, if only blank recordable discs with the RMID zone 114 are available on the market, then there is no effective way to copy the contents of the first disc to another disc in an unauthorized manner. Hence, it is envisioned that the RMID zones can be advantageously incorporated into particular formats and required by the standards that govern such formats.

Along these lines, the pre-recorded data in the RMID zone 114 (such as by the embodiments of FIGS. 3 and 4) can be further accessed and used to verify that the particular disc is an authorized disc; that is, even if the RMID zone does not return the PRID zone data, the data that are returned may be used to indicate that the disc is an authorized copy, particularly if unique serial numbers or other identifiers are provided to the discs. This may be useful, for example, when content providers elect to supply content on recordable discs in lieu of pre-recorded discs.

It is contemplated that unscrupulous copyists might attempt to “move” or reallocate the address(es) of the RMID zone 114 to another location within the data recording area 112 in an attempt to fool the system and defeat the protection scheme. However, this can be easily detected and prevented by, during the initialization process, causing the readback system 130 to not just seek to a particular sector or sectors to retrieve the RMID zone data, but to further ensure that the readback system 130 goes to the physical location of the RMID zone. This can be accomplished by verifying that particular phase distances and/or times from known points on the disc match with the returned RMID zone data (in other words, the RMID zone 114 is verified as being physically located where it is supposed to be located on the disc 110).

Any number of techniques can be utilized to configure the RMID zone 114 to make it unavailable for successful readback, as will readily occur to those skilled in the art in view of the foregoing discussion. While preferred embodiments have discussed optical discs, including DVD compatible discs, the invention is not so limited, but can be extended to any number of different types of media. Moreover, it is not necessarily required that the first disc 100 (i.e., the one being copy protected) be a pre-recorded disc; for example, the first disc can be a recordable disc or other form of medium.

In view of the foregoing, it will be understood that the present invention (as embodied herein and as claimed below) is generally directed to a recordable medium, an apparatus for forming the recordable medium, and a method of using the recordable medium for disc authentication and copy protection efforts.

In accordance with one aspect, a blank recordable medium (such as 110) generally comprises a plurality of concentric tracks arranged to form an addressable data recording area (such as 112) and a non-recordable zone (such as 114) embedded at one or more selected addresses within said data recording area configured to permit a recording operation to record data to said zone and to prevent successful readback of said data during a subsequent readback operation. Preferably, the recordable medium is characterized as an optical disc of a write-once or write-many format.

The non-recordable zone preferably comprises an embossment (such as FIGS. 3-4) provided during manufacture of the recordable medium, such as a metalized layer of pits and lands, a layer of optically contrasting marks within the recordable medium, or a layer of dye.

Preferably, a range of addressable sectors are defined by the plurality of tracks to provide the data recording area, and the non-recordable zone comprises at least one of said addressable sectors. The range of addressable sectors defined by the plurality of tracks is preferably defined by a frequency modulated pre-groove wobble of said tracks, and the pre-groove wobble can be disrupted at the non-recordable zone.

In accordance with another aspect, an apparatus (such as 170) is generally provided which forms a blank recordable medium having a non-recordable zone embedded within a data recording area as described above. The apparatus preferably comprises an embosser (such as 176) which supplies an embossment to the non-recordable zone, or otherwise disrupts the readback of data therefrom.

In yet another aspect, a method is generally provided in accordance with the foregoing discussion that includes a step of defining a disc authentication zone (such as 104) within an addressable data recording area (such as 102) of a first medium (such as 100) to correspond to a non-accessible zone (such as 114) embedded within an addressable data recording area (such as 112) of a second medium (such as 110). As before, the non-accessible zone is configured to permit a recording operation to attempt to record data thereto and to prevent successful readback of said data therefrom.

The method further preferably includes writing disc authentication information to the disc authentication zone which identifies the first medium as an authorized copy such that a subsequent attempt to use the second medium (such as by 130) to form a copy of the first medium results in an inability to retrieve the disc authentication information from the second medium (such as by 150). Preferably, the first medium is characterized as a pre-recorded optical disc and the second medium is characterized as a recordable optical disc, although the first medium can alternatively be characterized as a recordable optical disc as well.

For purposes of the appended claims, the phrase “permit a recording operation to record data” does not require that the recording operation is necessarily successful, or even completed, but rather that the non-recordable zone is considered by a recording system (at least initially) as an available address to which data can otherwise be written. Hence, this covers all of the embodiments presented herein, including the various alternative embodiments of FIGS. 3-5.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

In addition, although the embodiments described herein are directed to the provision of a non-recordable zone on a recordable optical disc for the purposes of providing disc authentication and copy protection of an original disc, it will be appreciated by those skilled in the art that such embodiments are for purposes of illustration and are not limiting, as other types of applications can readily be used without departing from the spirit and scope of the claimed invention.

What is claimed is:

1. A blank recordable medium comprising a plurality of concentric tracks arranged to form an addressable data recording area and a non-recordable zone embedded at one or more selected addresses within said data recording area, the non-recordable zone configured to prevent successful readback of data previously attempted to be written to said zone.

2. The recordable medium of claim 1, characterized as an optical disc.

3. The recordable medium of claim 2, wherein the optical disc is characterized as having a digital versatile disc (DVD) compatible format.

4. The recordable medium of claim 1, wherein the non-recordable zone comprises an embossment provided during manufacture of the recordable medium.

5. The recordable medium of claim 4, wherein the embossment comprises a metalized layer of pits and lands within the recordable medium.

6. The recordable medium of claim 4, wherein the embossment comprises a layer of optically contrasting marks within the recordable medium.

7. The recordable medium of claim 4, wherein the embossment comprises a layer of dye.

8. The recordable medium of claim 1, wherein a range of addressable sectors are defined by the plurality of tracks to provide the data recording area, and wherein the non-recordable zone comprises at least one of said addressable sectors.

9. The recordable medium of claim 1, wherein the range of addressable sectors defined by the plurality of tracks are defined by a frequency modulated pre-groove wobble of said tracks, and wherein said pre-groove wobble is disrupted at the non-recordable zone.

10. The recordable medium of claim 1, further comprising user data written to said data recording area.

11. The recordable medium of claim 1, characterized as a write-once medium so that, once data are written to the data recording area, such data cannot be erased.

12. The recordable medium of claim 1, characterized as a write-many medium so that, once data are written to the data recording area, such data can be subsequently erased.

13. An apparatus which forms the recordable medium of claim 1.

14. An apparatus which forms a blank recordable medium, said medium comprising a plurality of concentric tracks arranged to form an addressable data recording area and a non-recordable zone embedded at one or more selected addresses within said data recording area configured to permit a recording operation to record data to said zone and to prevent successful readback of said data during a subsequent readback operation.

15. The apparatus of claim 14, wherein the recordable medium is characterized as an optical disc.

16. The apparatus of claim 14, wherein the apparatus comprising an embosser which applies an embossment provided during manufacture of the recordable medium.

17. The apparatus of claim 14, wherein the apparatus defines a range of addressable sectors in the data recording area by frequency modulating a write beam to provide said tracks with a frequency modulated pre-groove wobble, and wherein the non-recordable zone comprises at least one of said addressable sectors.

18. A method comprising:
defining a disc authentication zone within an addressable data recording area of a first medium to correspond to a non-accessible zone embedded within an addressable data recording area of a second medium, the non-accessible zone configured to permit a recording operation to record data thereto and to prevent successful readback of said data therefrom; and
writing disc authentication information to the disc authentication zone which identifies the first medium as an authorized copy such that a subsequent attempt to use the second medium to form a copy of the first medium results in an inability to retrieve the disc authentication information from the second medium.

19. The method of claim 18, wherein the writing step further comprises writing user data to remaining portions of the data recording area of the first medium, and wherein the inability to retrieve the disc authentication information from the second medium prevents access to said user data.

20. The method of claim 18, wherein the first medium is characterized as a pre-recorded optical disc and the second medium is characterized as a recordable optical disc.

21. The method of claim 18, wherein first medium is characterized as a recordable optical disc and the second medium is also characterized as a recordable optical disc.

22. The method of claim 18, wherein the disc authentication zone comprises a first set of selected addressable sectors within the data recording area of the first medium, and wherein the non-recordable zone comprises a second set of selected addressable sectors within the data recording area of the second medium that corresponds to said first set.

23. The method of claim 18, further comprising accessing a location within a data recording area of a third disc corresponding to the disc authentication zone in an attempt to retrieve the disc authentication information.

24. The method of claim 23, further comprising identifying the third disc as an authorized copy of the first disc when the disc authentication information is successfully retrieved and granting access to remaining portions of the third disc.

25. The method of claim 23, further comprising identifying the third disc as an unauthorized copy of the first disc when the disc authentication information is unsuccessfully retrieved and denying access to remaining portions of the third disc.

26. An apparatus configured to carry out the method of claim 18.
